(19) United States
(12) Patent Application Publication
(10) Pub. No.: US 2016/0156698 A1
(43) Pub. Date: Jun. 2, 2016

(54) Fieldbus Access Unit and Method for Operating the Same

(71) Applicant: ENDRESS+HAUSER PROCESS SOLUTIONS AG, Reinach (CH)

(72) Inventors: Robert Kolblin, Lorrach (DE); Thorsten Deuser, Schontal (DE); Stefan Griner, Lausen (CH); Vincent De Groot, St. Louis (FR); Thomas Fridolin Dobele, Bad Sackingen (DE)

(21) Appl. No.: 14/906,148

(22) PCT Filed: Jun. 2, 2014
(86) PCT No.: PCT/EP2014/061373

§ 371 Date: Jan. 19, 2016

(30) Foreign Application Priority Data
Jul. 24, 2013 (DE) 10 2013 107 905.9

(51) Int. Cl. H04L 29/08; H04L 12/40

(52) U.S. Cl. CPC H04L 67/06; H04L 67/02; H04L 12/40169

(57) ABSTRACT

Method for operating a fieldbus access unit, wherein telegrams transferred via a fieldbus are tapped by the access unit, especially without the access unit participating in a data transmission via the fieldbus, wherein the field device information required for interpretation of tapped telegrams is downloaded from a superordinated unit based on identification data contained in the telegrams.

The invention relates to a fieldbus access unit and to a method for operating a fieldbus access unit.

Fieldbus access units are known from the state of the art, for example, from Offenlegungsschrift DE 102009046041 A1. Such fieldbus ,access units are able, among other things, to tap a communication occurring on the fieldbus, without participating in the communication on the fieldbus.

Likewise known from Offenlegungsschrift DE 102005063053 A1 is a fieldbus access unit, in the case of which data traffic on the fieldbus is tapped and in the case of a diagnostic event further diagnostic information is requested from the relevant field device. The fieldbus access unit shown there, which is referred to as a gateway, is connected besides with the fieldbus with a computer unit, which serves for observing field devices on the fieldbus.

Known from Offenlegungsschrift DE 102008019053 A1 is a comparable fieldbus access unit, there likewise referred to as a gateway, which, indeed, monitors data traffic on the fieldbus, however, not all data exchanged on the fieldbus, but, instead, only data referenced as wanted data, for example, only data coming from a certain transmitter, and transmits such in accordance with the protocol of a second network system to a superordinated unit. In such case, it is especially provided that for at least one field device, information for device integration of such field device, especially a GSD, is stored. Such information for device integration comprises, in such case, preferably information relative to the communication properties, etc. These GSDs can be loaded by a user from (any) data processing unit, which has a web browser, via the web server of the gateway into the gateway. Furthermore, the gateway provides a user via a web server a list of field devices, whose associated GSDs are stored in the gateway.

In such case, it is, however, disadvantageous that the user must actively furnish the required information in the form of files to the fieldbus access unit.

An object of the invention is to provide field device information required for evaluation of the data traffic on the fieldbus automatically.

The object is achieved by a method and by a fieldbus access unit.

As regards the method, the object is achieved by a method for operating a fieldbus access unit, wherein telegrams transferred via a fieldbus are tapped by the access unit, especially without the access unit participating in a data transmission via the fieldbus, wherein the field device information required for interpretation of tapped telegrams is downloaded from a superordinated unit based on identification data contained in the telegrams.

The terminology, interpretation, means, in such case, an evaluation of the telegrams as regards their content, especially the associating of numerical code contained in the telegrams with certain states of the field device, etc.

Of advantage is, furthermore, that, for example, after connecting an access unit to a fieldbus, via which field devices are communicating, no configuring must be done by a user, but, instead, the configuration occurs automatically, in that, such as provided, the required field device information is downloaded from a superordinated unit based on identification data.

In a form of embodiment of the method, the required field device information is the general station description, wherein the superordinated unit is a server, which provides a collection of files, which contain the required field device information, and wherein the general station description is downloaded via an Internet connection of the fieldbus access unit. Especially, the field device information can be the information contained in a so-called GSD, i.e. a general station description, or at least a part of the information contained therein.

In an additional form of embodiment of the method, the superordinated unit is an application on a computer unit, which application has access to the required field device information and wherein the required field device information is downloaded from the application via a communication connection between the fieldbus access unit and the application. The application can be, for example, the FieldCare program of the applicant.

In an additional form of embodiment of-the method, the required field device information is the general station description.

In an additional form of embodiment of the method, the required field device information is stored in a memory unit of the fieldbus access unit.

In an additional form of embodiment of the method, an updating of the present version of the required field device information is performed by means of the fieldbus access unit, when an Internet connection and/or a communication connection with an application is present.

In an additional form of embodiment of the method, at least one of the tapped telegrams contains diagnostic information, and wherein the required field device information serves for interpreting the diagnostic data.

In an additional form of embodiment of the method, the diagnostic information in the telegrams is in the form of bit strings.

By means of the field device information acquired by the fieldbus access unit, the bits strings can be interpreted, i.e. evaluated and presented as corresponding diagnostic reports in cleartext by means the fieldbus access unit.

In an additional form of embodiment of the method, the field device information required for the present fieldbus protocol standard is extracted, preferably by means of the fieldbus access unit, from a DTM associated with at least one field device.

Such methods are known from the state of the art; compare, for example, PROFIBUS device integration.

As regards the fieldbus access unit, the object is achieved by a fieldbus access unit for performing a method according to one of the above mentioned forms of embodiment. A corresponding fieldbus access unit can have, for example, a memory and a computing unit, which serve for performing the method. The method can be performed, for example, by program code means in the memory unit, respectively the fieldbus access unit. The program code means can be in the form of a programming language or a machine-readable language.

The invention will now be explained in greater detail based on the appended drawing, the sole FIGURE of which shows as follows:

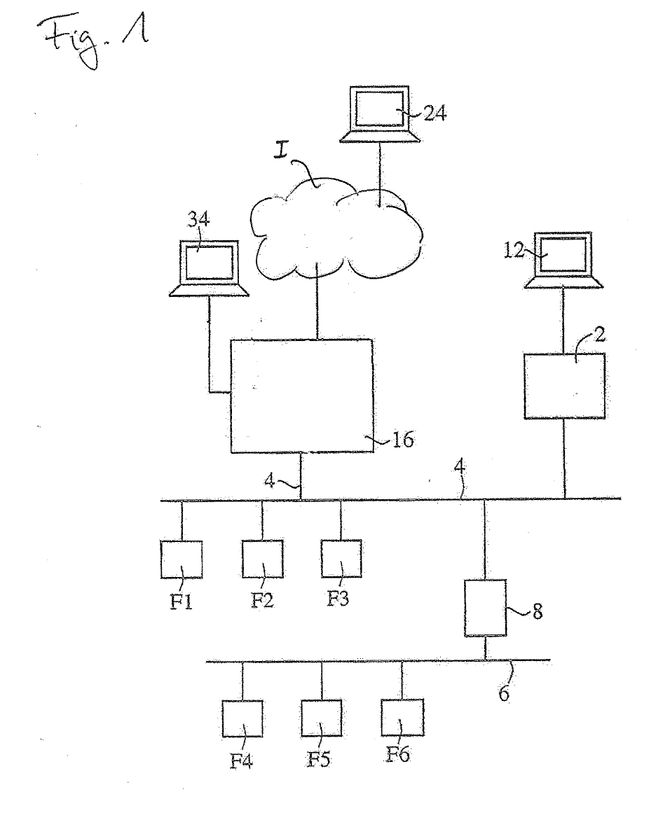

FIG. 1 a schematic representation of a plant of process automation technology for illustrating the method of the invention.

FIG. 1 shows a PLC 2, which is connected via a first network system 4 with three field devices F1, F2 and F3. The first network system 4 is formed, for example, by a Profibus DP network system. Furthermore, there is connected to the first network system 4 via a segment coupler 8 a further network system 6, which is formed, for example, by a Profibus PA network system. Connected to the additional network system 6 are three field devices F4, F5 and F6. The PLC 2 is a master of class 1. With reference to the field devices F1-F6, the PLC performs process control and communicates with the field devices in the context of cyclic data traffic. For example, it queries measured values from field devices, which are sensors, and issues as a function thereof control commands to field devices, which are actuators. Connected to the PLC 2 is, furthermore, a computer unit 12, which serves for servicing the PLC 2 and for visualizing data relative to the executed process control.

Further provided are first and second superordinated units 34, 24. In order to provide information, which is exchanged between the PLC 2 and one or more of the field devices F1-F6 in the context of process control, also to the first and/or second superordinated unit 34, 24, the first and second superordinated units 34, 24 are connected with the first network system 4 via a fieldbus access unit 16. The first and second superordinated units 34, 24 and the fieldbus access unit 16 are connected via a second network system. The first superordinated unit 34 can, in such case, be connected, for example, with the fieldbus access unit via a LAN, while the second superordinated unit is connected with the fieldbus access unit via the Internet.

Two superordinated units can be provided, such as in the example of an embodiment in FIG. 1, or only one of the two superordinated units can at least at times be connected with the fieldbus access unit.

The second superordinated unit 24 can be a web server, which can provide the required field device information and can transmit such via the Internet I to the fieldbus access unit 16.

A first form of embodiment of the method of the invention will now be described. The fieldbus access unit 16 is operated, for example, after connecting the fieldbus access unit 16 to the fieldbus 4, in a tapping mode, in which it monitors all or only selected communications, i.e. communications of a certain type or a certain sender, which are exchanged between the PLC 2 and the field devices F1-F6 in the context of process control.

In the fieldbus access unit 16, these communications, which are present, for example, in the form of telegrams, are then examined as regards, for example, a device identification number. Such a device identification number, which gives, for example, the device manufacturer and the device type, is furnished, for example, in the HART protocol, in the part of the telegram referred to as the address bit; compare http://bhmea.bh.funpic.de/files_JG5/PRT/download/feldbus_js_V 38-1295534911.pdf—telegram construction. Thus, each device possesses a unique address not changeable by the user.

Similar and, as concerns purpose, equal identification numbers are also used in the protocols, Profibus and Foundation Fieldbus.

Based on the identification data, then field device information is downloaded from the superordinated unit 34 or 24.

For example, data can be exchanged via a LAN connection between the fieldbus access unit 16 and the superordinated unit 34 embodied as a computer unit. Via such a connection, then both the identification data can be transmitted to the superordinated unit 34 as well as also the field device information can be transmitted from the superordinated unit to the fieldbus access unit 16. This data transmission can, however, only take place when the superordinated unit 34 is connected with the fieldbus access unit 16, for example, via an on-site communication interface on the fieldbus access unit 16, and the field device information is accessible by means of the superordinated unit 34, for example, when an application for servicing one or more field devices is present.

On the other hand, it can also be provided that the fieldbus access unit is connected via the Internet with the superordinated unit 24. In such case, the superordinated unit 24 can, for example, be embodied as a server. Present in the server can be an extensive collection of field device descriptions or just the required field device information, which can be downloaded by means of the identification data of a field device F1-F6. For such purpose, there can be provided in the fieldbus access unit 16 a client, which issues corresponding queries to the server, preferably via the Internet I or via a connection including the Internet I.

The field device information can either be extracted by means of the superordinated unit 34, 24 from a device description such as, for example, a DTM or a DD, or the device description can be transmitted to the fieldbus access unit 16 via the corresponding connection and the information extracted by, respectively in, the fieldbus access unit 16 from the device description.

### LIST OF REFERENCE CHARACTERS

34 first superordinated unit
24 second superordinated unit
I Internet
16 fieldbus access unit
4 first network system
6 second network system
F1-F3 field devices on the first network system
F4-F6 field devices on the second network system
12 programmable logic controller PLC
2 computer unit
8 segment coupler

1. Method for operating a fieldbus access unit, wherein telegrams transferred via a fieldbus are tapped by the access unit, especially without the access unit participating in a data transmission via the fieldbus, wherein the field device information required for interpretation of tapped telegrams is downloaded from a superordinated unit based on identification data contained in the telegrams.

2. Method as claimed in claim 1, wherein the required field device information is the general station description, wherein the superordinated unit is a server, which can provide a collection of files, which contain the required field device information, and wherein the general station description is downloaded via an Internet connection of the fieldbus access unit.

3. Method as claimed in claim 1, wherein the superordinated unit is an application on a computer unit, which application has access to the required field device information and wherein the required field device information is downloaded from the application via a communication connection between the fieldbus access unit and the application.

4. Method as claimed in claim 1, wherein the required field device information is the general station description.

5. Method as claimed in claim 1, wherein the required field device information is stored in a memory unit of the fieldbus access unit.

6. Method as claimed in claim 1, wherein an updating of the present version of the required field device information is performed by means of the fieldbus access unit, when an Internet connection and/or a communication connection with an application is present.

7. Method as claimed in claim 1, wherein at least one of the tapped telegrams contains diagnostic information, and wherein the required field device information serves for interpreting the diagnostic data.

8. Method as claimed in claim 1, wherein the diagnostic information in the telegrams is in the form of bit strings.

9. Method as claimed in claim 1, wherein the field device information required for the present fieldbus protocol standard is extracted, preferably by means of the fieldbus access unit, from a DTM associated with at least one field device (F1-F6).

10. Fieldbus access unit for performing a method as claimed in claim 1.
